(19) United States
(12) Patent Application Publication
(10) Pub. No.: US 2018/0091939 A1
(43) Pub. Date: Mar. 29, 2018

(54) GEOFENCED ACCESS POINT MEASUREMENT DATA COLLECTION

(71) Applicant: QUALCOMM Incorporated, San Diego, CA (US)

(72) Inventors: Sai Pradeep VENKATRAMAN, Santa Clara, CA (US); Aditya SRIVASTAVA, Fremont, CA (US); Gengsheng ZHANG, Cupertino, CA (US)

(21) Appl. No.: 15/275,149

(22) Filed: Sep. 23, 2016

(51) Int. Cl. H04W 4/02; H04B 17/318

(52) U.S. Cl. CPC H04W 4/021; G01S 19/42; H04B 17/318

(57) ABSTRACT

Method, mobile device, computer program product, and apparatus relating to designating and implementing a geofence containing an AP measurement data configuration. The AP measurement data configuration may be used to specify how a mobile device should to perform while within the geofence. The AP measurement data configuration may include instructions to control collection such as: “disable,” “passive,” and “batch.”

### FIELD

The subject matter disclosed herein relates generally to Access Point measurement data collection and distribution within geofences, and more specifically collection configurations within geofences.

### BACKGROUND

Electronic devices may include a variety of sensors and inputs to monitor and infer relative device position. For example, based on input received by a WiFi sensor, a device can measure Received Signal Strength Indication (RSSI) or Round Trip Time (RTT) to infer device position relative to one or more wireless access points. In another example, a Global Navigation Satellite System (GNSS) can be used to determine device position. Through a combination of device measurements, Access Point (AP) locations may be determined within an environment.

To survey and determine AP positions, mobile devices may use passive scanning techniques comprising periodic scans to sample AP and mobile sensor data. For example, the process of discovering/mapping AP positions within an indoor environment can include scanning WiFi APs to retrieve machine access control (MAC) addresses, RSSI, or other measurement data. While scanning WiFi APs, a mobile device may also estimate its location (for example, upon getting a GNSS fix of the mobile device) and attempt to associate the location with the measurement data from the WiFi APs. In response to filling a local buffer with AP measurement data, the mobile device may send the AP measurement data and any associated location data to a server for processing and mapping of the APs. However, the data sent to the server may include erroneous or irrelevant data when the mobile's location is unreliable. Also, the mobile may continuously send data regardless of whether the server has a specific need for the data. Therefore, new and improved data collection techniques are desirable.

### SUMMARY

Embodiments disclosed herein may relate to designating a geofence containing an AP measurement data configuration to specify how a mobile device should to perform while within the geofence. In some embodiments, the AP measurement data configuration may include instructions to control collection such as: “disabled” (for example, perform no AP measurements or location tracking while in the geofence, such as when an area has been thoroughly measured/fingerprinted from prior measurement sessions), “passive” (for example, perform AP measurements when resources are available) and “post-processed” (for example, complex or active AP measurement techniques).

Embodiments disclosed herein may relate to a mobile device to post-process measurement data configured to: obtain a geofence defining a geographically bounded area within an environment; determining a mobile device is located within the geofence; select an AP measurement configuration to implement in response to determining the mobile device is within the geofence, wherein the AP measurement configuration includes at least one of adjusting AP measurement collection to one or more of: disabled, passive, or post-processed configurations; and configure the mobile device for AP measurement according to the AP measurement configuration associated with the geofence.

Embodiments disclosed herein may relate to a method geofenced AP measurement data collection, the method comprising: obtaining a geofence defining a geographically bounded area within an environment; determining a mobile device is located within the geofence; selecting an AP measurement configuration to implement in response to determining the mobile device is within the geofence, wherein the AP measurement configuration includes at least one of adjusting AP measurement collection to one or more of: disabled, passive, or post-processed configurations; and configuring the mobile device for AP measurement according to the AP measurement configuration associated with the geofence.

Embodiments disclosed herein may relate to a machine readable non-transitory storage medium having stored therein program instructions that are executable by a processor for: obtaining a geofence defining a geographically bounded area within an environment; determining a mobile device is located within the geofence; selecting an AP measurement configuration to implement in response to determining the mobile device is within the geofence, wherein the AP measurement configuration includes at least one of adjusting AP measurement collection to one or more of: disabled, passive, or post-processed configurations; and configuring the mobile device for AP measurement according to the AP measurement configuration associated with the geofence.

Embodiments disclosed herein may relate to an apparatus for performing geofenced data collection, the apparatus comprising: means for obtaining a geofence defining a geographically bounded area within an environment; means for determining a mobile device is located within the geofence; means for selecting an AP measurement configuration to implement in response to determining the mobile device is within the geofence, wherein the AP measurement configuration includes at least one of adjusting AP measurement collection to one or more of: disabled, passive, or post-processed configurations; and means for configuring the mobile device for AP measurement according to the AP measurement configuration associated with the geofence.

The above and other aspects, objects, and features of the present disclosure will become apparent from the following description of various embodiments, given in conjunction with the accompanying drawings.

### BRIEF DESCRIPTION OF THE DRAWINGS

FIG. 1 is block diagram illustrating an exemplary operating environment in which embodiments for Geofenced Access Point Measurement Crowdsourcing (GAPMC) may be practiced;

FIG. 2A illustrates a method for GAPMC implemented at a mobile device, in one embodiment;

FIG. 2B illustrates a method for GAPMC implemented at a mobile device, in another embodiment;

FIG. 3 illustrates a method for mobile device or server implemented GAPMC, in one embodiment;

FIG. 4 illustrates a method for GAPMC implemented by a server, in one embodiment;

FIG. 5 illustrates an environment for performing GAPMC, in one embodiment;

FIG. 6 is block diagram illustrating an exemplary device in which embodiments GAPMC may be practiced.

### DESCRIPTION

Aspects of the invention are disclosed in the following description and related drawings directed to specific embodiments of the invention. Alternate embodiments may be devised without departing from the scope of the invention. Additionally, well-known elements of the invention may not be described in detail or may be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

In one embodiment, a device may obtain a designated geofence (for example, a location (i.e., x-y coordinates, latitude-longitude, or other) and a radius or polygon area), and crowdsourcing parameters. The crowdsourcing parameters can specify how the mobile device should perform while within the geofence. For example, the crowdsourcing parameters may include: “disabled” (for example, perform no AP measurements or location tracking while in the geofence, such as when an area has been thoroughly measured/fingerprinted from prior measurement sessions), “passive” (for example, perform AP measurements when resources are available), and “post-processed” (for example, complex or active AP measurement techniques).

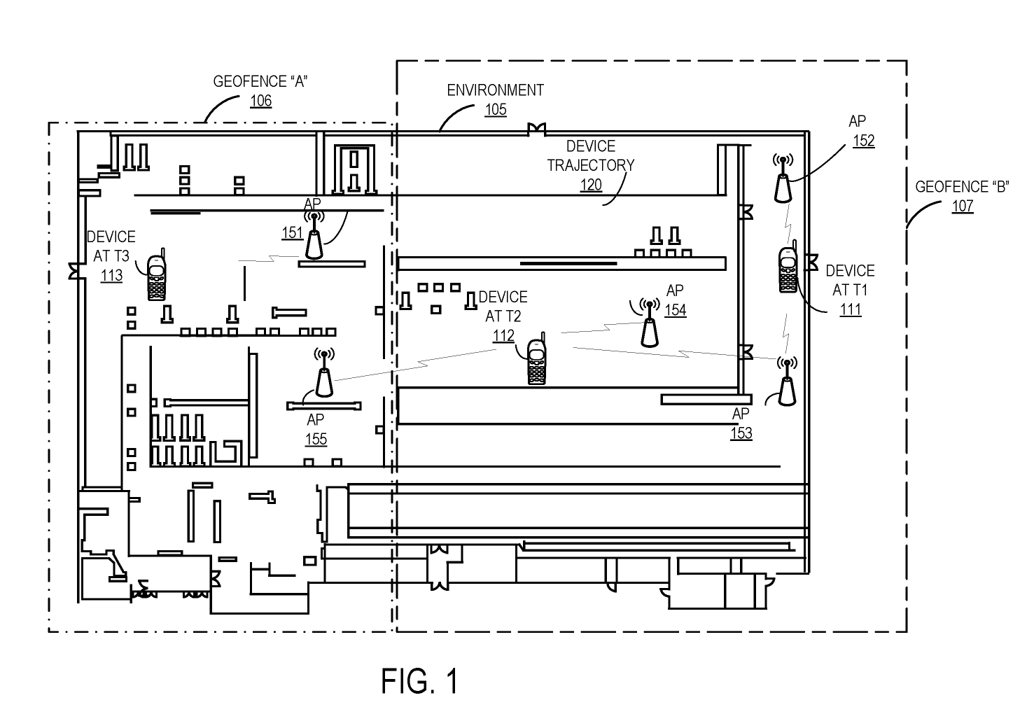

FIG. 1 is block diagram illustrating an exemplary operating environment in which embodiments for Geofenced AP Measurement Crowdsourcing (GAPMC) may be practiced. In one embodiment, a device (for example, a mobile device as illustrated in various positions along trajectory 120 at times T₁ 111, T₂ 112, and T₃ 113) moves within an environment (for example, indoor environment 105). In some embodiments the environment is a venue, building, or structure, referred to herein as simply the (device) environment or location. As used herein, the term “mobile device” refers to a device that may from time to time have a position that changes. Such changes in position may comprise changes to direction, distance, orientation, etc., as a few examples. The mobile device may have integrated positioning capability above and beyond GAPMC as described herein (for example, motion sensors, GNSS, WiFi positioning, etc.) to determine the position of the mobile device at specified time intervals. In some embodiments, positioning capabilities of the device (for example, GNSS) may become unreliable or inaccessible (for example, when the device is deep indoors and not near a window or opening). In one embodiment, as a device moves about the environment into and within one or more geofenced areas (for example, geofence “A” 106, and geofence “B” 107), GAPMC can implement one or more different AP measurement configurations associated with the geofenced area.

At some positions within environment 105, a mobile device may be unable to determine the absolute position or existence of APs within the location. For example, the mobile device may not have access to both GNSS and a map of the location. In one embodiment, as the mobile device traverses the location, GAPMC discovers APs, performs range measurements, and also tracks relative movement with mobile device motion sensors (for example, accelerometer, gyroscope, and others). The AP map may contain discovered AP's positions relative to points on a path or trajectory of the mobile device. GAPMC can store the AP map in memory of the mobile device. In one embodiment, an AP measurement configuration for a geofenced area may configure a mobile device to a “post-processed” process as a way to send one or more aspects of the AP map to a server. In other embodiments, an AP measurement configuration for a geofenced area may configure a mobile device to disable or otherwise deactivate AP measurement within the geofenced area. In yet other embodiments, an AP measurement configuration implements passive or simple AP measurement data collection within an area. For example, passive AP measurement may include detecting WiFi MAC addresses and associating the WiFi MAC addresses with best available positions in areas defined by one or more geofences.

In one embodiment, while within a post-processed AP measurement configuration area, mobile devices store their trajectory (for example, device trajectory 120) as determined from their motion sensors within the mobile device. In some embodiments, various positions along a trajectory are associated with AP measurements obtained at that particular position. The positions may be updated when more accurate positions are determined, such as when GNSS is obtained. For example, as illustrated in FIG. 1, device at time T1 111 may record radio signal measurements from APs 152 and 153, while at time T2 112 the device may record radio signal measurements from APs, 153, 154, and 155. In one embodiment, when a GNSS and/or other position fix may be detected with high confidence, the mobile device may align the prior trajectory to update positions via backfiltering the pedestrian dead reckoning (PDR) positioning data from the position fix of high confidence. In one embodiment, the mobile device may estimate position and trajectory of a mobile device based on information gathered from various systems (for example, mobile device motion sensors and PDR). One such system may comprise a wireless network compatible with one or more of the Institute of Electrical and Electronics Engineers (IEEE) 802.11 wireless local access network (WLAN) standards, which may also be referred to as a WiFi network. Such a network may include wireless transmitters/receivers (for example, APs 151-155) sometimes referred to as beacons, for example. Accuracy or availability of traditional mobile device positioning systems may depend, at least in part, on wireless access point mapping via trilateration, where information related to wireless access points including estimated positions may be stored in a database or other storage type on a server. A position estimate, which may also be referred to as a position “fix,” for a mobile device may be obtained based at least in part on distances or ranges measured from the mobile device to one or more wireless APs, and may also be based at least in part on knowledge of the positions of the one or more wireless APs. In one embodiment, a mobile device may not have access to a wireless AP database and may not have access to absolute AP locations/coordinates.

A mobile device may interface with wireless communication components including, for example, cellular communication systems, wireless local area networks, or other types of wireless communication systems. Wireless communication of the mobile device may employ one or more wireless transmitters/receivers that may be referred to as “base stations” or “access points,” for example. As used herein, the terms “base station” and “access point,” represent example types of wireless-transmitters, although the scope of claimed subject matter is not limited in this respect. As used herein, the term “AP” is meant to include any transmitter or transmitter/receiver of wireless signals compatible with any type of wireless communication system. For example, an AP may be Bluetooth device transmitting over a protocol defined by the trade organization Bluetooth Special Interest Group (SIG).

The term “AP” is also meant to include any wireless communication station or device utilized to facilitate communication in a wireless communications system, such as, for example, a cellular network, although the scope of claimed subject matter is not limited in this respect. An example type of wireless transmitter utilized in a cellular network may be referred to as a base station. In another aspect, a wireless transmitter may comprise a femtocell, utilized to extend cellular telephone service into a business or home, for example. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet. In another aspect, wireless APs may be included in any of a range of electronic device types. In an aspect, a wireless AP may comprise a WLAN AP, for example. Such a WLAN may comprise a network that is compatible with one or more of the IEEE 802.11x standards, in an aspect, although the scope of claimed subject matter is not limited in this respect. In another aspect, a wireless AP may include a BLE beacon. In yet another aspect, a wireless AP may include a base station or eNodeB or other network element of a wireless wide area network (WWAN) such as LTE, CDMA, CDMA2000, UMTS, GSM, or other similar networks. Additionally, the use herein of the term “AP” in describing a device does not limit that device's function to transmitting only. For example, base stations and access points are typically capable of both transmitting and receiving wireless signals.

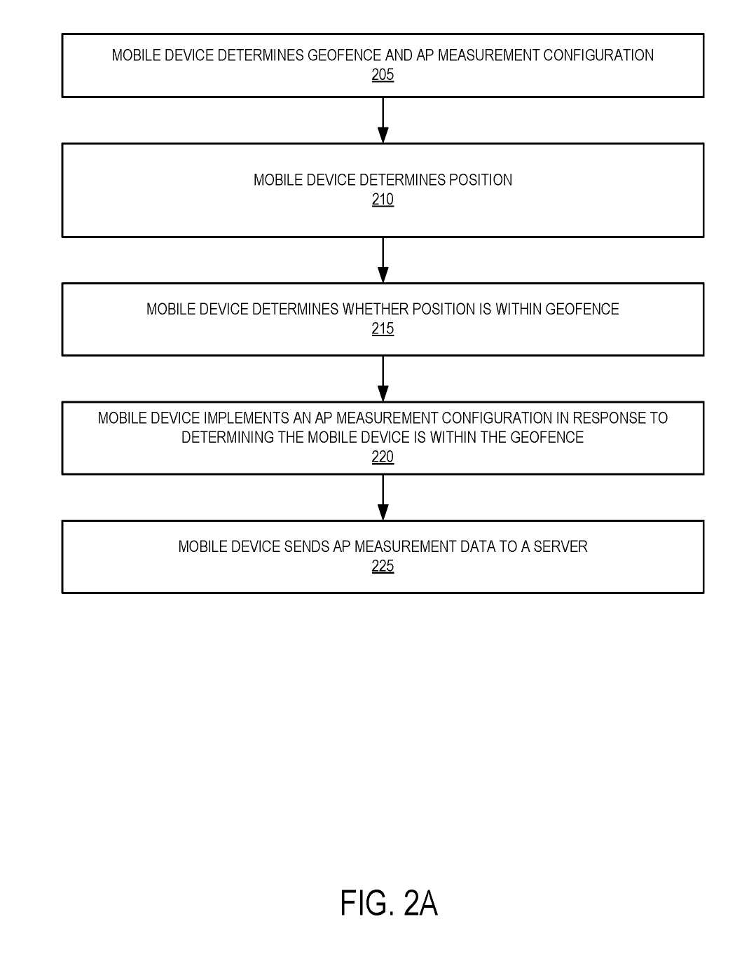

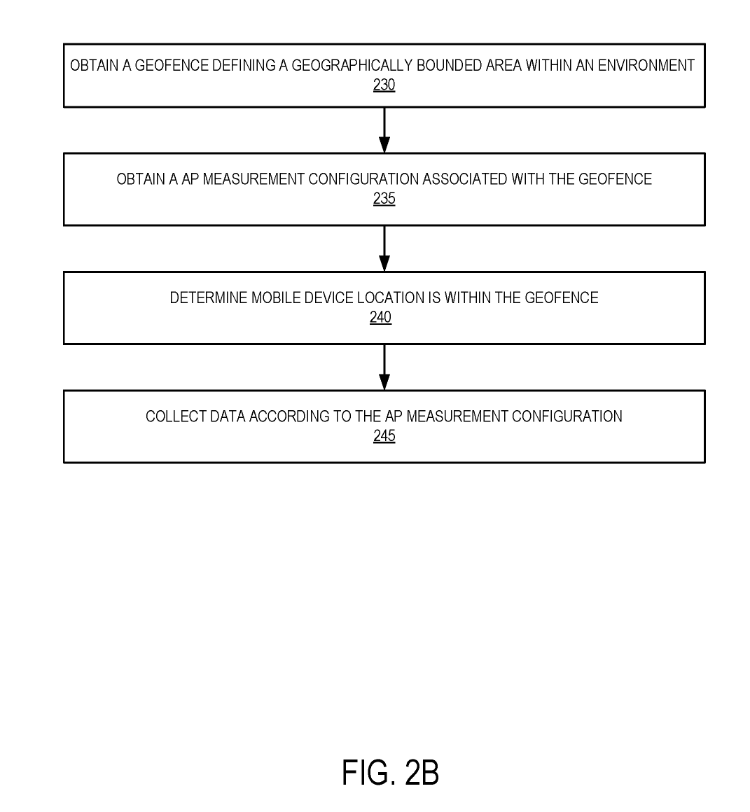

FIG. 2A illustrates a method for GAPMC implemented at a mobile device, in one embodiment. At block 205, the mobile device determines geofence and AP measurement configuration. For example, the mobile device may track areas within an environment that the mobile device has already provided AP mapping and can adjust future AP measurement sessions to disable AP measurement within well-covered geofenced areas. The mobile device may also determine it is in an indoor environment, and utilize post-processing techniques for enhanced AP mapping in an area with limited GNSS position fixes. In some embodiments, the AP measurement configuration may include general parameters determined by an administrator or a server and the mobile device implements and interprets the general parameters in real time. For example, the mobile device may receive an AP measurement configuration requesting AP measurement data while inside and not when outside and the mobile device may use proximity, camera, ambient light, or other sensors to determine (for example, independent of any map data) whether the mobile device is likely inside or outside. In some embodiments, the AP measurement configuration may request measurements in a particular city or building type (for example, mall or commercial but not residential, residential but not commercial, and other configurations are possible) and the mobile device may calculate particular geofenced areas based determining the city or building type meets the general parameters requested in the AP measurement configuration. In some embodiments, a local mobile device or user-defined configuration may override or alter one or more aspects or settings from a received AP measurement configuration. For example, a user may request that no AP measurements are performed at work, home, or other specified location despite a general server request for AP measurement for a larger location (for example, geofence) that includes the user's work or home.

In some embodiments, the AP measurement configuration and associated geofence may be based on available network bandwidth or a preferred bandwidth usage configuration of the mobile device. For example, the mobile device may have a limit on data available to dedicate towards AP measurement data crowdsourcing and the mobile can prioritize certain areas over other areas accordingly. If the mobile device receives compensation or rewards for crowdsourcing within a particular area, the mobile may configure AP measurement data accordingly. The mobile device may also limit crowdsourcing for areas the mobile has already processed and can set a geofence around an area to avoid repeat data collection, storage, and processing for future collection. In some embodiments, the mobile device can limit AP measurement data collection when a user follows a specified or predicted mobility pattern. For example, the mobile device may recognize crowdsourcing within a user's neighborhood, home, work, or other visited areas and detect the mobile device has provided measurements in the area already. Therefore the mobile device can determine when there is no need to continue AP measurement collection in certain recognized areas.

At block 210, the mobile device determines position. For example, the mobile device may utilize GNSS or one or more mobile sensors to determine current position of the mobile device within an environment.

At block 215, the mobile device determines whether the determined position is within a geofence. For example, GNSS coordinates may indicate the mobile device is within a shopping mall that is tagged for post-processing of AP measurement data. Or the GNSS coordinates may indicate the mobile device is at a particular address within a geofenced area. In some embodiments, when a new environment (for example, a venue) is visited, the mobile may increment a counter for number of visits such that future visits may be adjusted based on historical coverage. In some embodiments, a total count may be assigned by a server such that the mobile device decrements the counter until reaching 0, at which time the mobile device may limit or disable AP measurement data collection for a particular geofence. In some embodiments, because other mobile devices may also be recording AP measurement data for a geofence, the decrement to the counter may be sent by the server without the mobile device actually performing all iterations of a survey for a particular environment. In some embodiments, new APs or missing APs may cause a counter to be adjusted to provide further investigation for the environment.

At block 220, the mobile device implements an AP measurement configuration in response to determining the mobile device is within the geofence. For example, if the geofence is an area of particular interest, the mobile device may perform either passive/simple AP measurement or post-processed AP measurement. In some embodiments, the mobile may determine post-processed AP measurement is appropriate for indoor locations. Alternatively, the geofence may define an area where there is sufficient data and hence the AP measurement configuration could be set to disabled.

In some embodiments, the mobile device can configure WiFi measurement for a geofence while Bluetooth data collection is disabled, or Bluetooth measurement collection may be enabled while WiFi is disabled depending on data density already covered in the geofence. Hence, the AP measurement configuration may be associated with a particular wireless technology. Furthermore, in some embodiments, there may be multiple AP measurement configurations, each of the multiple AP measurement configuration being for a different associated wireless technology. In one example, there may be a first AP measurement configuration and a second AP measurement configuration, and the first AP measurement configuration may be associated with a first wireless technology while the second AP measurement configuration is associated with a second wireless technology. In one implementation, the first AP measurement configuration is associated with WiFi/WLAN while the second AP measurement configuration is associated with one of Bluetooth Low Energy (BLE) or wireless wide area network (WWAN) (including femtocells). In an implementation where the second AP measurement configuration is associated with WWAN, the AP measurement configuration can include indications for the collection by the mobile device of time of flight (ToF) measurements of signals to and from base stations of the WWAN.

In some embodiments, the mobile device configuration includes a global on/off switch to determine whether the mobile will participate in crowdsourcing. In some embodiments, the mobile device may be context aware of the user activities such that either location or time based rules can be created to limit crowdsourcing.

At block 225, the mobile device sends the measurement data to a server. In some embodiments, such as passive/simple measurement collection the mobile will send data to a server whenever an internal buffer is full, or may continuously update the server as data is collected. The data sent to the server in passive/simple collection may be unprocessed or raw data such that the server may perform post-processing on the data to strip out errors or inconsistencies, or to calculate more precise positioning for one or more of the collected measurements.

In some embodiments, such as for post-processed data in a post-processing configuration, AP positions are estimated and refined at the mobile device before sending to the server. In some embodiments, a set of mobile devices may work in parallel to provide their measurement batches of post-processed data to the server (for example, in a crowdsourced/group processing and distribution). Each measurement batch may be associated with the respective mobile device that recorded and processed its measurement batch. In some embodiments, further refinement of the batch data may be performed at a server receiving the measurement batch. In some embodiments, the server receives un-processed batches and post-processes and/or backfilters the received data. In some embodiments, even when the server receives post-processed batches, the server may further reduce errors by crowdsourcing a plurality of measurements from a plurality of devices. In one embodiment, passive data collection occurs when each AP measurement scan is associated with a particular positioning fix. In contrast to passive data collection, post-processing of the collected data may include determining position at some point in time after AP measurement data is collected. In some embodiments, received mobile device position(s) may be initially unknown or may be a rough or unrefined estimate. Through post-processing, AP measurement scans may be associated with a refined or updated position fix. Hence, in a post-processed configuration, the mobile device can post-process device position data calculated over a prior period of time at the end of a data batch. In some embodiments, the end of the data batch can be defined by an end-AP-data-collection trigger.

Post-processed AP measurements may include the mobile device determining that a new position fix has a high confidence (e.g., GNSS) and correcting/updating previously estimated intermediate locations (for example, to correct lower accuracy positioning from pedestrian dead reckoning, or other mobile sensor based positions computed prior to the new position fix having the high confidence) associated with prior AP measurements. For example, in response to entering a geofenced area, the mobile device may begin recording AP measurements (while computing position fixes along a trajectory) until a high confidence position fix is determined. In response to determining the high confidence position fix, the mobile device can post-process the previously computed intermediate position fixes to generate improved or corrected intermediate position fixes. The mobile device can send the improved or corrected intermediate positioning data and associated AP measurements to a server, or may process the data to map out AP locations on the mobile device. Mobile devices may be equipped with satellite based navigation systems for determining position and providing navigation assistance. A global navigation satellite system (GNSS) such as, for example, the Global Positioning System (GPS) may send timing signals used by mobile devices to estimate the position of the mobile device. However, in some situations mobile devices may be unable to receive the satellite timing signals. For example, when a mobile device is indoors, in a canyon, in the shadow of tall buildings, or other environment that may block satellite signals. In such circumstances, sensor equipped mobile devices can perform PDR to estimate the mobile device's position, for example an intermediate position along a trajectory. However, accuracy is limited by magnetic disturbances inside structures, sensor precision, and other unknown variables such as device position, bias, and differences in stride. Additionally, PDR error from use of mobile device sensor data is typically magnified over time as every new positioning error is compounded with previous errors.

Reliance on PDR when GNSS is unavailable may lead to inaccurate positioning while mobile devices gather AP measurement data for an environment. For example, mobile devices may be utilized in a crowdsourced system to determine information (for example, location) for APs in an environment. AP location errors may be especially pronounced in indoor environments where PDR or GNSS averaging is used to estimate AP locations.

In one embodiment, a device utilizes various timing and processing techniques to create a measurement batch including collected AP measurement data and associated mobile device positioning data. In one embodiment, a mobile device may use a GNSS position fix, or other high accuracy position fix, to correct potentially less accurate historical mobile sensor based positioning (for example, PDR). A mobile device may traverse an indoor environment and measure AP signals while also tracking current position using the best available positioning methods. In some embodiments, the best available positioning methods may be determined from mobile device motion sensors, such as what may be used as input for determining PDR, which may be used instead of the GNSS due to the building blocking GNSS signals. However, typical PDR can be relatively inaccurate over anything but short distances due to drift and other sensor errors that multiply over time. Therefore, measurement post-processing will take PDR and AP measurements collected while the mobile is within an indoor environment, and post-process the currently collected PDR and AP measurement data together with an updated mobile device position having a higher accuracy. For example, PDR may have a low confidence accuracy, however when a high confidence position is determined (for example from GNSS) the previous intermediate PDR positioning data may be improved or corrected (for example through backfiltering using a Kalman filter of positioning prior data) according to the acquired GNSS fix (new position). This process may be performed by a server or directly by the mobile device. If post-processing is performed by the mobile device, and the AP measurement data is sent along with corrected/improved positioning data as described above to a server, such data maybe referred to as a measurement batch. This can be distinguished from passive measurement techniques where a mobile device simply records AP measurement data and associated position fixes, and sends the data to the server either in real-time or as a group for use by a server without post-processing at the mobile device, although post-processing may be performed by the server.

In one embodiment, measurement post-processing enables radio measurements from one AP to be accurately associated with improved intermediate positions leading to better AP position estimates than previous techniques. Additionally, some radios like BT may only be seen during a short period where traditional techniques may miscalculate or ignore their measurements. In one embodiment, measurement post-processing with backward propagation or smoothing enables the computation of position fixes during intermediate broadcast times and allows for position assignments to the BT devices that are observed during these times. In some embodiment, propagation with PDR in the forward direction may be enough for calculating AP positioning, however smoothing of the PDR may be enabled as an additional refinement to obtain more accurate intermediate positions. Additionally, measurement post-processing allows for mobile APs, seen fleetingly during the mobile device's trajectory to be identified and prevented from being erroneously included in a final positioning database. Furthermore, the mobile device may utilize occasional position fixes combined with PDR events instead of relying on constant on high power positioning methods such as GNSS.

FIG. 2B illustrates a method for GAPMC implemented at a mobile device, in another embodiment. At block 230, the mobile device obtains a geofence defining a geographically bounded area within an environment. In one embodiment, the mobile device may obtain the geofence or parameters for the geofence from a mobile device internal memory. For example, the geofence parameters may be received from a server or they may be computed by the mobile device and stored in the internal memory. In one embodiment, the mobile device obtains the geofrence by receiving the geofence or parameters for the geofence from a server.

At block 235, the mobile device obtains an AP measurement configuration associated with the geofence. In one embodiment, the mobile device obtains the AP measurement configuration from a mobile device internal memory. For example, the AP measurement configuration associated with the geofence may be received from a server or the configuration may be determined by the mobile device. In one embodiment, the measurement configuration includes one or more of: a disabled configuration, a passive configuration, or a post-processed configuration. In one embodiment, the mobile device does not collect AP data according to the disabled configuration. In another embodiment, the mobile device collects data based on signals received from APs, for example, WLAN, WWAN, and/or BLE APs according to the passive configuration. In such a configuration, the mobile device computes a position at various times and simultaneously collects AP ID, RSSI or other signal strength indicator, RTT or other ToF indicator, without performing post-processing. As used herein, post-processing refers to improving the real-time or near real-time positioning computations along a trajectory after the real-time or near real-time position. In a passive configuration, measurement data may be “batched” in the sense that the data does not need to be sent to the server in real time or all at once. Rather, the data can be collected and then later sent to the server in a “batch,” however, such measurement data would still conform to a passive configuration so long as the positioning data (for example, the intermediate position fixes) associated with the AP measurement data is not post-processed, that is, as long as computed intermediate positions are not later improved after being computed, for example, when after a plurality of intermediate positions are computed, a new position is computed with a high reliability, and post-processing is used to improve the intermediate position fixes along the trajectory.

In another embodiment, the mobile device collects data based on signals received from APs, for example, WLAN, WWAN, and/or BLE APs according to the post-processed configuration. For example, in one embodiment of a data batch in a post-processed configuration, the mobile device may compute positions of the mobile device along a trajectory with several intermediate positions beginning with an initial position fix having high confidence, for example, a GNSS and/or other position fix having high confidence. The intermediate positions can be computed using PDR. After computing the intermediate positions, the mobile device may be able to compute a new high confidence position, for example, where the confidence or accuracy of the new high confidence position is greater than the confidence of any, most, or all of the intermediate positions. In such a case, the mobile device may post-process the intermediate positions to compute corrected or improved intermediate positions based on the new high confidence position. For example, the mobile device may align the computed trajectory (comprising the intermediate positions) to the high confidence new position fix and to correct or improve previously computed intermediate PDR-derived positions via backfiltering. AP measurement data taken along the trajectory can now be associated with the new corrected or improved intermediate positions. Such backfiltering can be performed using extended Kalman filtering (EKF). The data (including the AP measurement data and the corrected or improved positioning data) may then be sent to the server as a single batch or multiple batches. Such a data batch can provide more efficient data than a passive configuration, for example.

At block 240, the mobile device determines that it is located within the geofence. Based upon the determination that the mobile device is located within the geofence, the mobile device can collect data according to the AP measurement configuration associated with the geofence. In some embodiments, the mobile device may determine whether the device is within a geofence according to available and/or appropriate sensors for the particular location. For example, the mobile device may also determine from available sensors, such as an ambient light or camera sensor, whether the device is indoors or outdoors as part of the determination whether the device is within a particular geofence.

At block 245, the mobile device collects data according to the AP measurement configuration. In various embodiments, the AP measurement configuration can be one of disabled, passive, or post-processed configurations. In a disabled configuration, the mobile device does not collect AP measurement data. For example, in an area where there is sufficient data, a geofence corresponding to the area can be associated with the disabled configuration. In various embodiments where the AP measurement configuration is passive, the mobile device does little or no post-processing of positioning data. However, in the passive configuration, AP measurement and mobile positioning data can be sent to the server in one or more data bundles or, alternatively, in real time. Post-processing may, or may not, be performed at the server based on data collected by the mobile device in the passive configuration and sent to the server. As discussed above, in the post-processed configuration, the mobile device may collect AP measurement data and may post-process mobile device positioning data to improve the mobile device positioning data and therefore improve estimates of AP location using the AP measurement data and the improved mobile device positioning data. In the passive and post-processed configurations, a data “batch” may be defined by an end-AP-data-collection or batch trigger. The batch trigger could include exiting the geofence, a transition event of the mobile device (such as determining the mobile device has exited a building, a car, or an environment, going from outdoors to indoors, etc.), or position reliability falling below a threshold (for example, as when the mobile device begins to collect data upon entering the geofence, and after losing GNSS signals, the mobile device begins to compute positions using PDR, however, after a certain amount of time, the computed PDR positions begin to become unreliable). In the post-processed configuration, the end-AP-data-collection trigger can also include computing a new position with a reliability that is higher than one or more intermediate position computations. When collecting data according to the passive and/or post-processed configuration, the mobile device can collect AP measurements and mobile positioning data (including computing mobile position using PDR). For example, the mobile device can perform one or more of: radio frequency signal strength measurement, radio frequency based distance estimation to an AP, initializing one or more motion sensors at the mobile device, calculating GNSS based position, or any combination thereof.

In some embodiments, the mobile device collects or sends data according to whether the server has the data from a previous crowdsourcing session. For example, the mobile device may have already sent the same or similar data to the server. In another example, the mobile device may be aware of whether other mobile devices have sent the same or similar data. In some embodiments, the mobile device may make a determination of data quality before collecting and sending data to the server. For example, the server may have a large quantity of low quality data and still want further measurement data to improve existing coverage. In some cases, the server may have data that is good or acceptable but the time stamp or age of the data is past a threshold data age and therefore new and additional data is beneficial. The threshold data age may be reference dependent, such that BLE may trigger more frequent data collection compared to WiFi AP related data. In some embodiments, the mobile device and/or server can detect changes in the network or map of the area and can update the AP measurement configuration (i.e., AP measurement configurations may evolve over time).

Once the AP measurement data and mobile positioning data is collected, it can be sent to the server in one or more data bundles, with or without post-processing. The mobile device may bundle the data by grouping the data together in a single data bundle without performing any filtering or updating of intermediate positions. For example, a data bundle could be defined as all data collected within the geofence defined by the server, and all AP measurement and position computations collected while within the geofence can be considered a bundle and sent to the server in one or more groups, for example, after the data has been collected. Defining the end of a data bundle could be based on an end-AP-data-collection trigger.

In some embodiments, the mobile device performs self-learning for whether an area has been previously crowdsourced and post-processed and then switch to a “maintenance” or reduced feature mode. For example, compared to an initial discovery mode a maintenance mode may be less power intensive or aggressive with regards to type and source of AP measurements performed.

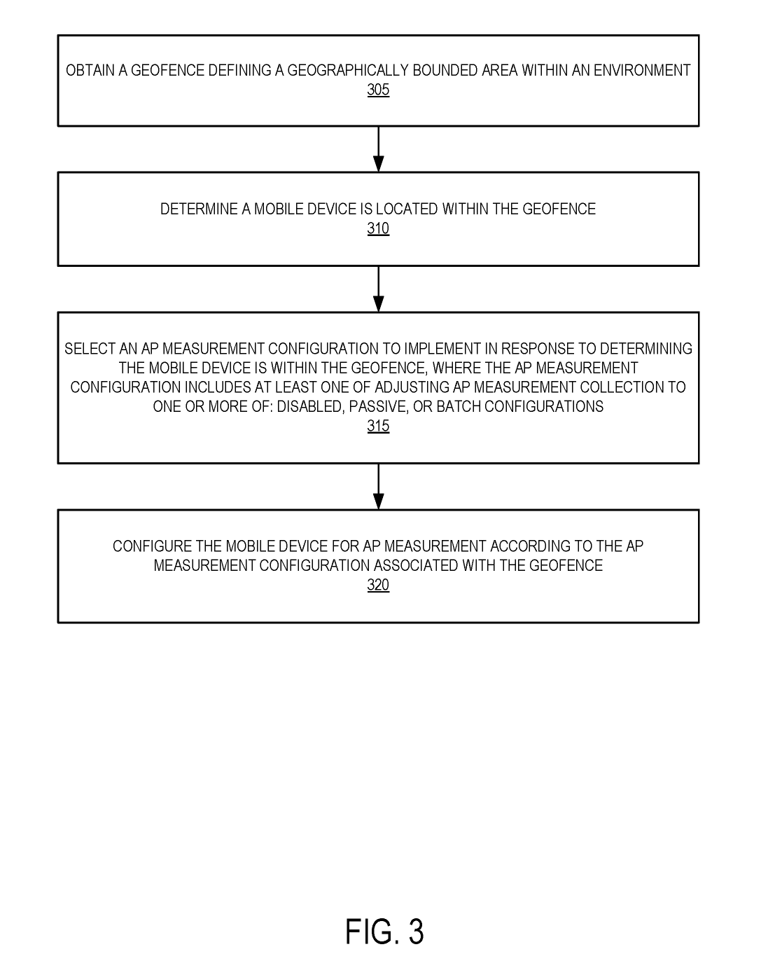

FIG. 3 illustrates a method for implementing GAPMC by a server or mobile device, in another embodiment. At block 305, the mobile device or server (for example, GAPMC) obtains a geofence defining a geographically bounded area within an environment. In some embodiments, mobile device users in a dangerous environment can configure a geofence to suspend all non-essential functions.

At block 310, the mobile device or server determines a mobile device is located within the geofence.

At block 315, the mobile device or server selects an AP measurement configuration to implement in response to determining the mobile device is within the geofence, where the AP measurement configuration includes one or more of: disabled, passive, or post-processed configurations, or any combination thereof. In one embodiment, post-processing a batch of data includes updating or correcting or improving mobile device position data calculated over a prior period of time, where the mobile device position data has an associated accuracy estimate, and the end of a batch segment is defined by the associated accuracy estimate reaching a threshold confidence.

At block 320, the mobile device or server configures the mobile device for AP measurement according to the AP measurement configuration associated with the geofence. In some embodiments, the mobile device may suspend all AP measurement data collection if it detects battery consumption is reaching critical levels, or according to other user defined preferences at the mobile device. The AP measurement may include the mobile device performing one or more of: radio frequency signal strength measurement, radio frequency based distance estimation to an AP, initializing one or more motion sensors at the mobile device, calculating GNSS based position, or any combination thereof.

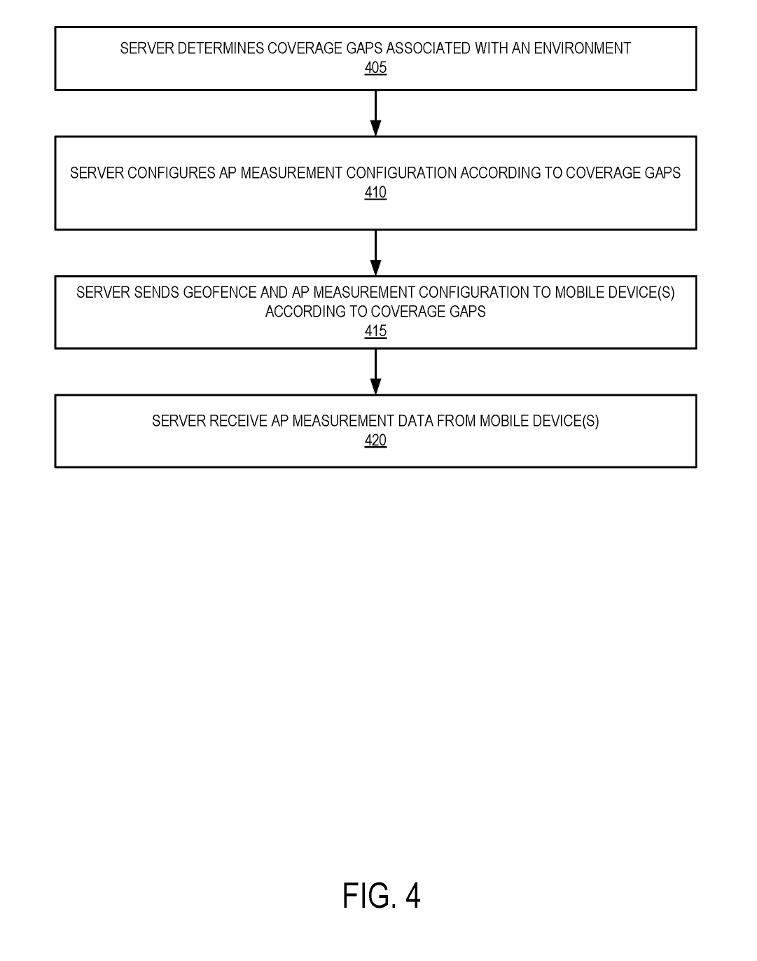

FIG. 4 illustrates a method for GAPMC implemented by a server, in one embodiment. GAPMC can use server side optimization of configuration files to limit unnecessary crowdsourcing in certain environments and promote crowdsourcing in other areas. A server may actively assist mobile devices in the field by updating requests for the most valuable or currently missing data at the server. Server directed GAPMC can reduce power and storage used by mobile devices and can reduce the total data transfer between mobile devices and the server. In some embodiments, a server may compensate mobile device crowdsourcing with enhanced privileges for data. For example, if a user allows crowdsourcing to occur on their mobile device, the user may be granted upgraded positioning, or other performance enhancing features. In some embodiments, opting in to crowdsourcing may also grant certain users financial benefits in addition to or instead of device performance enhancements. Other models or schemes may be implemented to improve crowdsourcing participation.

At block 405, the server (for example, GAPMC) determines coverage gaps associated with one or more areas in an environment. For example, the server can track areas where density of uploaded data may be less than a threshold amount, and request more or less data accordingly. For example, the server can determine the AP measurement data configuration for a given environment, for example a geographic area, based on a quality or density of AP measurement coverage previously obtained by the server in the given environment. Based on this, in some embodiments, the server may “draw” or determine geofences according to perceived data gaps in an environment. A geofence may be a polygon or other shape covering the area where the server has sufficient data, or where a server seeks out additional data. For some environments, the geofenced area may be a portion or subsection of the entire location and the server may set up multiple geofences for the environment. Data sufficiency may be based on reliability of APs within an area. For example, if an AP is reliable and does not change position repeated or frequent data collection for the area associated with the AP may be unnecessary. In some cases data collection for an area or specific AP may be available by other means that may be prioritized over crowdsourcing. For example, venue fingerprinting or AP position broadcasting may be considered highly reliable and preferred over crowdsourcing data. Therefore, in some embodiments a geofence defining a high confidence data area may be disabled or otherwise turned off for crowdsourcing.

Crowdsourced data may most frequently be obtained from high traffic areas (for example, ground floor of buildings, outside areas, mall corridors, etc.), however to promote AP measurement data gathering in areas of lower data density, the server can create and send geofences with associated AP measurement data configurations for such areas. In one embodiment, mobile devices have the option to view the geofences on a map if they are interested in actively participating in crowdsourcing. Mobile devices may override or edit server recommended geofenced boundaries in some embodiments.

In some embodiments, a network provider (for example, cell service provider) may request a specific AP measurement data configuration for a given geofence.

At block 410, the server configures an AP measurement configuration and geofence according to the coverage gaps determined at block 405. In one embodiment of passive/simple AP measurement data the mobile device may use unique AP identifier collection, RSSI and/or RTT or other signal measurements usable for positioning, and best available positions (which may include PDR-derived positions). In one implementation, passive/simple AP collection may include collecting raw AP measurement data just mentioned along with positions and sending such data in real-time as they are measured to the server, or it may send the data in batches. For measurements in the post-processed configuration, the mobile device may collect and post-process AP measurement data and mobile device position data before sending a batch of data back to the server.

At block 415, the server sends a geofence and AP measurement configuration to one or more (crowdsourced) mobile devices according to the coverage gaps. For example, the server may determine one or more mobile devices are likely to enter a geofenced area where additional data collection would be beneficial and may send out an AP measurement configuration requesting the mobile devices collect data for the geofenced area. In some embodiments a server may send end-AP-data-collection trigger configuration to a mobile device. Server provided guidance may be integrated in each mobile device in a crowdsourced network of mobile devices. The guidance may include instructions as to when to initiate PDR, WiFi scanning, and BT scanning, as well as when to determine position fixes from GNSS, visible light communication positioning data, precise indoor positioning (PIP), or other similar methods for accurate position determination. In some embodiments, measurement batching guidelines determine how the mobile device stores WiFi/BT measurements, timestamps, PDR step events, turn angles, GNSS, visible light communication positioning data, PIP fixes, UNCS, and any associated timestamps.

At block 420, the server receives measurement data from mobile devices. For example, the server may receive either or both passive/simple unprocessed data or post-processed data processed by the mobile device in batches. In some embodiments, the mobile device sends information to identify the measurements originated from one or more batches provided by a particular mobile device. The identification of the mobile device may be a device identification (ID) or any unique identifier that indicates which data a batch came from. For example, when receiving multiple batches, the server can use identification tags to group batches by device. In some embodiments, a server can assign higher weights to some comprehensive data over other types of data. In other words, server can de-weight other data that it has received about a specific AP in the form of geotagged or non-geotagged reports. In some embodiments, data from newer devices with improved or different sensor configurations could be given higher weight than older or less efficient devices. Additionally, a moving or active device may give more consistent data than a stationary device because RSSI (or other measurement) may not be relative to sources and locations (i.e., measurements would not be recorded from a diversity of APs measured relative to a diverse set of data).

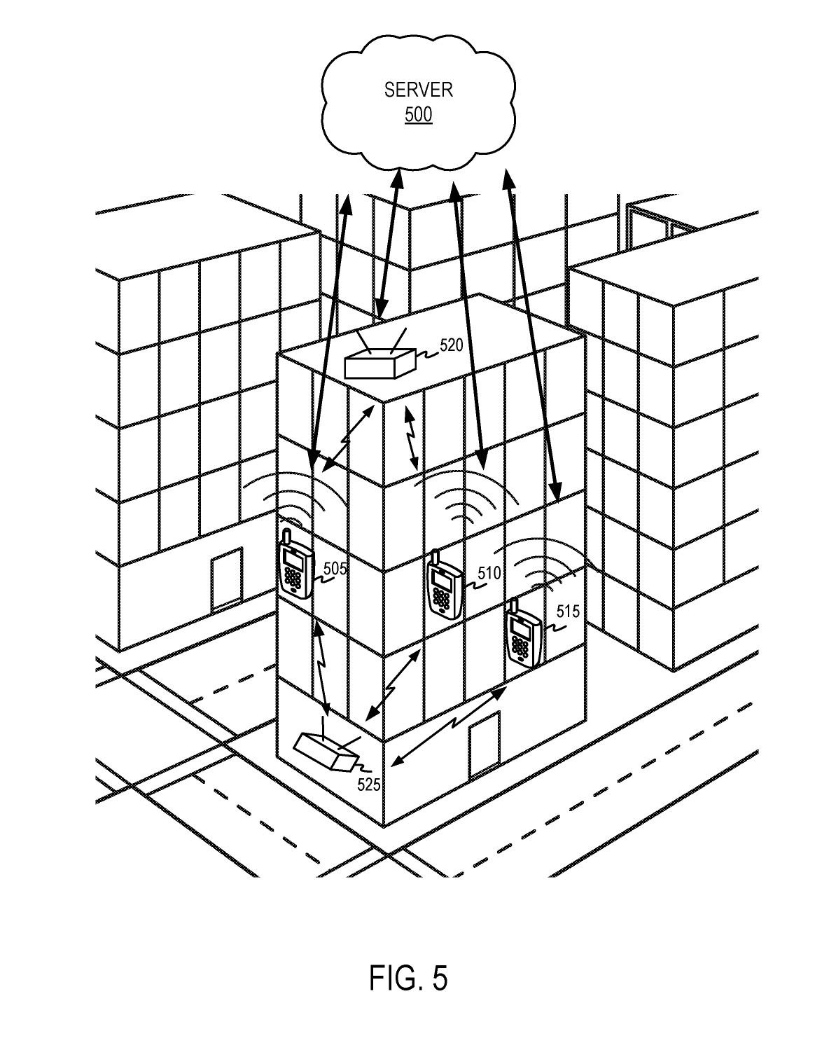

FIG. 5 illustrates an example environment for performing GAPMC. As discussed above, a server (for example, server 500) may actively prepare and distribute AP measurement configurations associated with geofenced areas. The server may distribute configurations to one or more mobile devices within an environment (for example, mobile devices 505, 510, and 515). While within the geofenced environment, the mobile device(s) may measure AP signal data and mobile device position data, as discussed above, to map one or more APs or beacons (for example, AP 520 and AP 525). The APs may be Bluetooth, WiFi, or other radio frequency (RF) beacons, as discussed above.

In one embodiment, a mobile device can read device sensor data to determine context or position. For example, a mobile device can create context data, or data related to the environment of the device by polling or extracting data from one or more of the mobile device sensors described above. As one example, the mobile device may receive positioning information from a GPS or from WiFi positioning to determine a location of the device. The mobile device may also read camera images or data from a camera sensor to determine information about the device environment (for example, whether the device is indoors or whether any detectable landmarks are visible). Using the context data, the mobile device or server can determine further information about the environment/location. For example, the mobile device may extract longitude and latitude coordinates from the GPS, and determine the coordinates are associated with a specific building or section of a building. In one embodiment, based on positioning or location information received from each mobile device, the server can create a recommended AP measurement configuration for mobile devices performing data collection for a particular geofenced area. To create the AP measurement configuration, the server may first determine what if any data gaps exist within the location database.

In one embodiment, guidelines may be stored within a location database and can include Location Data and/or recommended data collection configurations. Mobile devices can receive a guideline from the server. The guideline may include information to assist the device in providing accurate positioning or localization. For example, within an indoor shopping mall, GPS positioning may be most accurate when the mobile device is positioned near windows or other openings. In this indoor shopping mall example, a guideline may include Location Data to help the device more accurately determine position within the shopping mall such that the mobile device can activate or deactivate one or more sensors as appropriate for the given location. The Location Data may include location specific features, landmarks, or identifiers as described above.

The mobile device can refer to the guideline to optimize the positioning configuration of the mobile device when in a particular geofenced area. For example, if the mobile device receives a guideline that indicates the mobile device location has few windows or other location features that promote efficient access to communication outside of the current building, the mobile device may automatically turn off GPS or other satellite communication features within the geofence. If the guideline indicates the respective geofenced area has windows that may allow for a weak GPS signal, the mobile device may determine a GPS can be polled occasionally (for example, reduced usage model) instead of being activated continuously (for example, constant on model). The guideline may include details to allow the mobile device to determine proximity to a window or open area that may potentially offer more accurate GPS signal reception.

In one embodiment, the positioning guideline optimizes the data collection such that a mobile device can collect data on an as needed basis if within the geofence. The server may send a recommended positioning configuration or guideline including specific position data collection requests from the mobile device when within the geofence. For example, the server may determine that Location Data for a location has incomplete or partial knowledge about WiFi access points within an environment and communicate the request to the mobile device. Although the mobile device may not necessarily need to collect WiFi data in order to perform user functions (for example, navigation), the mobile device may nonetheless accept the server recommendations to help update the Location Data on the server (for example, as part of location database). Therefore, the server may request individualized data collection from a group or “crowd” of mobile devices in order to maintain and update the location database on the server which can include various types of Location Data.

GAPMC may maintain updated location features/attributes based on crowdsourcing data collection from one or more devices (for example, mobile devices/devices). For example, as a device navigates an indoor location (for example, shopping mall), data collected during navigation may be sent to the GAPMC server to update and maintain location features. In one embodiment, the server can use GAPMC functionality in conjunction with one or more mobile devices to crowdsource AP measurement data. GAPMC can intelligently throttle or adjust the amount or type of subsequent AP measurement updates sent by each respective mobile device. In one embodiment, the server can send a recommended guideline to the mobile device related to recommended frequency of data collection, which sensors to activate, how often to send measurement batches to the server, or what type of data to collect in one or both of a guideline and an AP measurement configuration.

In one embodiment, a mobile device can apply a recommended guideline upon determining whether the configuration or guideline is compatible with the respective device settings and geofenced area. For example, user supplied settings may restrict the use of GPS when battery is low or have privacy settings to limit the use of camera sensors even though the guideline (for example, configuration file sent from the server) may recommend GPS or camera activation.

As introduced above, a recommended guideline from a server also includes Location Data. As used herein, Location Data may include Location Context Identifiers or other data related to a physical location. For example, Location Data can include: a map of the location (for example, including building or floor layout and points of interest), number of known access points, historical data traffic, device activity associated with the position or location, or other known location features.

Location Data may be subdivided into multiple sub-locations such that a user or device can download or access the section of Location Data relevant to a current location. As the user or device moves from one location to another, the Location Data related to the current location may be accessed locally or downloaded from a server. In other embodiments, the server may automatically determine related Location Data that a device may need based on direction of movement or position of the device or which geofenced area the mobile device is within.

In one embodiment, the Location Data stored at the server (for example, within the location database) may be determined by a baseline data collection sequence from one or more mobile devices or a pre-seeded database. During one or more initial position data collection sessions by one or more mobile devices, GAPMC at the server may obtain additional Location Data as described above. Subsequent mobile device data collection received by the server can be used to maintain and keep the location database up to date. For example, upon detecting a mobile device within a respective location, the server may compare incoming data collection at that location to current Location Data on the server. If the Location Data received by the server is more up to date or adds additional Location Data, the location database at the server may be updated. The updated Location data can be used to benefit subsequent mobile device connections when the Location Data is requested (for example, per geofenced area) by a mobile device.

In one embodiment, updating of AP measurement data configurations by a mobile device is triggered when a change in the received position data (for example, data related to a particular location) is detected. For example, a mobile device may determine three WiFi access points are detected in a location when ten access points are expected based on prior data collection (for example, stored within the location database at the server). Based on a change in position data indicating the mobile device has position uncertainty, the mobile device can updated its local AP measurement data configuration to perform further measurements within the geofence. In some embodiments, a server can create a guideline to recommend the mobile device to turn on additional sensors or increase the frequency of positioning calculations for subsequent data collections by one or more devices in response to receiving requests from one or more mobile devices for a gap in data coverage within a geofence.

In one embodiment, the server triggers creation and sending of the recommended AP measurement data configurations to a device when a threshold amount of time has lapsed since a previous data collection. For example, the server can determine that AP measurement data for a particular location is outdated, and request one or more devices to provide updated data. The server can send a recommended configurations to collect the updated AP measurement data from one or more devices at the respective geofence defining the outdated coverage environment.

In one embodiment, the server can recommended AP measurement data configurations that are different for each location or venue. For example, one recommended configuration may be associated with a specific shopping mall and a different recommended configuration for a specific office building. Furthermore, different sections/geofences within a location may trigger different configurations. For example, the lobby of an office building may have different location features and higher foot traffic than an office space on a higher level of the building. Based on the different features of the respective location, the server can adjust the data collection parameters that are requested or sourced from the devices within the geofence.

In some embodiments, the AP data measurement configuration is adjusted according to the available features of the device (for example, whether the device has Bluetooth, accelerometer, WiFi, or other capability used to determine position or context for the device environment). For example, one device may have Bluetooth and WiFi, while other devices may be lacking Bluetooth but have multiple cameras or a magnetometer. Depending on capability, different AP measurement configurations can be sent from the server to the device. For example, a BT and GNSS enabled device may be able to provide detailed BT positioning information to a server. In another example, a device has WiFi and visible light communication, but no GNSS, the configuration may request using visible light communication when available for a high confidence position fix in a geofence.

In one embodiment, the mobile device or server determines a level of AP measurement data to collect based on amount of data collected over a period of time. Depending on the capture time of the most recent position data for a location, the next data collection may be more or less data intensive, or occur earlier or later. For example, after 6 months without new or updated position data for a geofence, the mobile device may resume requests for data collection at the geofence.

In one embodiment, when a server or mobile device determines a change in positioning performance surpasses a predetermined threshold, a new recommended AP measurement configuration for a geofence may be created. For example, the mobile device may monitor RSSI and RTT calculations for APs at a particular location. Based on changes in measurement of the RSSI and RTT for a geofence compared to historical levels of RSSI and RTT, the server or mobile device can trigger additional or fewer sensors to aid in device positioning. In other words, the AP measurement configuration can be updated based on degradation of positioning in a particular environment, such as a geofence. For example, APs within a previously sufficiently crowdsourced area may move and/or change enough to degrade positioning performance, and hence, for a given geofenced area, the AP measurement configuration, for example, may change from disabled to a passive or a post-processed AP measurement configuration. In addition, it is understood that the boundaries of a geofence may change, or a previously defined geofence may be eliminated and new geofence defined.

In alternate embodiments, the mobile device or server may adjust the intensity or frequency of data collection for existing sensors based on a change in historical levels of RSSI and RTT. For example, an access point may fail or be removed from a location, resulting in different RSSI and RTT values from previous data collection sessions. The mobile device or server may recommend additional data collection from devices within the geofence based on the change in recorded RSSI and RTT. For example, additional data collection may include additional sensors or increased robustness for existing sensors.

In one embodiment, devices connected to the server can self configure with an updated guideline configuration. Devices may use some or none of the recommended configurations from the server when implementing a new data collection guideline. For example, the server may request a mobile device to collect BT position data and send to the server. However the device may be low on battery and the device may determine that BT monitoring should remain deactivated until the device battery can be recharged. In some embodiments, the server can receive a battery level (for example, or any other status) from the device and create a customized recommended configuration according to battery level (or other status) of the particular device while in a geofence.

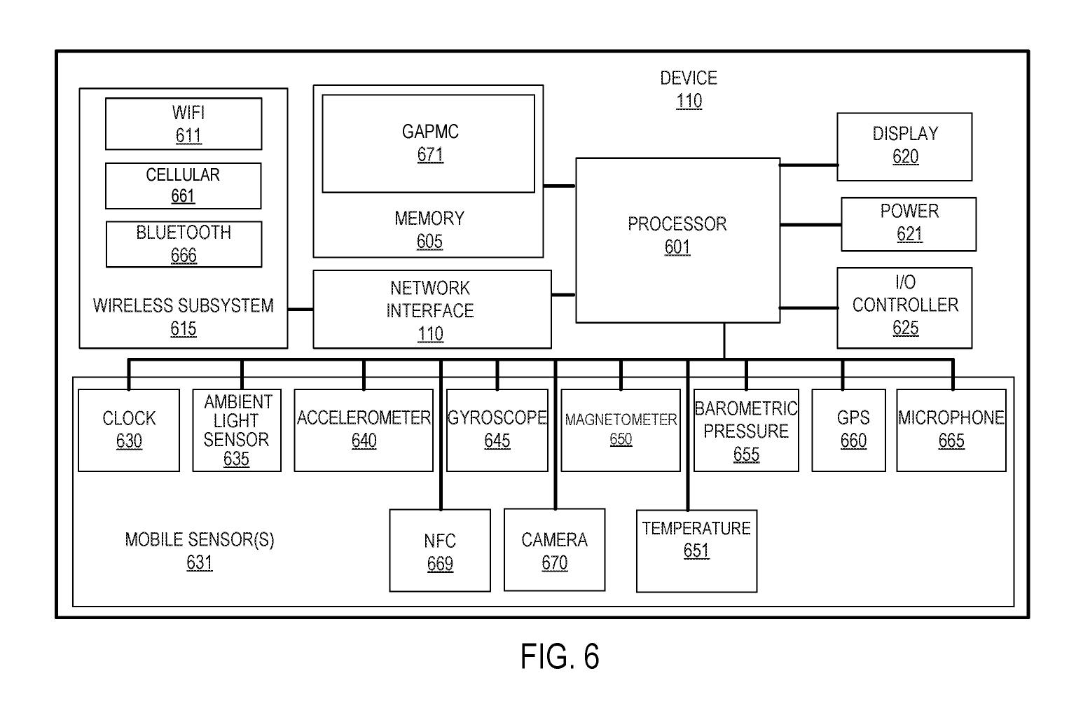

FIG. 6 is block diagram illustrating an exemplary device in which embodiments of GAPMC may be practiced. GAPMC described herein may be implemented as software, firmware, hardware, module, or engine. In one embodiment, the methods described herein may be implemented by one or more general purpose processors (for example, processor 601) in device 600 in memory 605 to achieve the previously desired functions (for example, the method of FIGS. 2A, 2B, 3, and 4). In some embodiments, processor 601, together with memory 605 and other components described herein, can serve as: means for obtaining a geofence defining a geographically bounded area within an environment; means for obtaining an AP measurement configuration associated with the geofence, where the AP measurement configuration includes one or more of: disabled, passive, or post-processed configurations; means for determining a device is located within the geofence; and means for collecting data according to the AP measurement configuration. In some embodiments, processor 601, together with memory 605 and other components described herein, can also serve as: means for obtaining a second AP measurement configuration associated with the geofence and associated with a second wireless technology different from the first wireless technology, where the second AP measurement configuration includes one or more of: disabled, passive, or post-processed configurations; and means for collecting the data according to the AP measurement configuration includes means for the mobile device to perform one or more of: radio frequency signal strength measurement, radio frequency based distance estimation to an AP, initializing one or more motion sensors at the mobile device, calculating GNSS based position, or any combination thereof.

Device 600 may be a mobile device (for example, the mobile devices illustrated in FIG. 1), or a server, and may include one or more processors 601, a memory 605, I/O controller 625, and network interface 610. Device 600 may also include a number of device sensors coupled to one or more buses or signal lines further coupled to the processor 601. It should be appreciated that device 600 may also include a display 620, a user interface (e.g., keyboard, touch-screen, or similar devices), a power device 621 (for example, a battery), as well as other components typically associated with electronic devices. In some embodiments, device 600 may be server that does not contain one or more example sensors (for example, motion sensors).

Device 600 can include sensors such as a clock 630, ambient light sensor (ALS) 635, accelerometer 640, gyroscope 645, magnetometer 650, temperature sensor 651, barometric pressure sensor 655, compass, proximity sensor, near field communication (NFC) 669, and/or Global Positioning Sensor (GPS or GNSS) 660. As used herein the microphone 665, camera 670, and/or the wireless subsystem 615 (Bluetooth 666, WiFi 611, cellular 661) are also considered sensors that may be used to analyze the environment (for example, position) of the device.

Memory 605 may be coupled to processor 601 to store instructions for execution by processor 601. In some embodiments, memory 605 is non-transitory. Memory 605 may also store one or more engines or modules to implement embodiments described below. Memory 605 may also store data from integrated or external sensors. In addition, memory 605 may store application program interfaces (APIs) for accessing aspects of GAPMC as described herein. In some embodiments, GAPMC functionality is implemented in memory 605. In other embodiments, GAPMC functionality is implemented as a module separate from other elements in the device 600. The GAPMC module may be wholly or partially implemented by other elements illustrated in FIG. 6, for example in the processor 601 and/or memory 605, or in one or more other elements of device 600.

Network interface 610 may also be coupled to a number of wireless subsystems 615 (e.g., Bluetooth 666, WiFi 611, Cellular 661, or other networks) to transmit and receive data streams through a wireless link to/from a wireless network, or may be a wired interface for direct connection to networks (e.g., the Internet, Ethernet, or other wireless systems). Device 600 may include one or more local area network transceivers connected to one or more antennas. The local area network transceiver may include suitable devices, hardware, and/or software for communicating with and/or detecting signals to/from WAPs, and/or directly with other wireless devices within a network. In one aspect, the local area network transceiver may include a WiFi (802.11x) communication system suitable for communicating with one or more APs (for example, APs).

Device 600 may also include one or more WWAN transceiver(s), for example as a part of the Cellular 661 subsystem, that may be connected to one or more antennas. The wide area network transceiver comprises suitable devices, hardware, and/or software for communicating with and/or detecting signals to/from other wireless devices within a network. Furthermore, WWAN transceiver mobile device 600 can be used in collecting AP measurement data based on signals received from base stations in the WWAN according to an AP measurement configuration received by the mobile device 600 from a server associated with a particular geofence. In one aspect, the wide area network transceiver may comprise a CDMA communication system suitable for communicating with a CDMA network of wireless base stations; however in other aspects, the wireless communication system may comprise another type of cellular telephony network or femtocells, such as, for example, TDMA, LTE, Advanced LTE, WCDMA, UMTS, 4G, or GSM. Additionally, any other type of wireless networking technologies may be used, for example, WiMax (802.16), Ultra Wide Band, ZigBee, wireless USB, etc. In conventional digital cellular networks, position capability can be provided by various time and/or phase measurement techniques. For example, in CDMA networks, one position determination approach used is Advanced Forward Link Trilateration (AFLT). Using AFLT, a server may compute its position from phase measurements of pilot signals transmitted from a plurality of base stations.

Thus, device 600 may be a: wireless device, cell phone, personal digital assistant, mobile computer, wearable device (e.g., head mounted display, watch, glasses, etc.), robot navigation system, tablet, drone, automotive component, internet of things (IoT) integrated device, personal computer, server, laptop computer, or any type of device that has processing capabilities. As used herein, a mobile device may be any portable, or movable device or machine that is configurable to acquire wireless signals transmitted from one or more wireless communication devices or networks. Thus, by way of example but not limitation, device 600 may include a radio device, a cellular telephone device, a computing device, a personal communication system device, or other like movable wireless communication equipped device, appliance, or machine. The term “mobile device” is also intended to include devices which communicate with a personal navigation device, such as by short-range wireless, infrared, wire line connection, or other connection—regardless of whether satellite signal reception, assistance data reception, and/or position-related processing occurs at mobile device 600. Also, “mobile device” is intended to include all devices, including wireless communication devices, computers, laptops, etc. which are capable of communication with a server, such as via the Internet, WiFi, or other network, and regardless of whether satellite signal reception, assistance data reception, and/or position-related processing occurs at the device, at a server, or at another device associated with the network. Any operable combination of the above are also considered a “mobile device.”

A mobile device may communicate wirelessly with a plurality of APs using RF signals (e.g., 2.4 GHz, 3.6 GHz, and 4.9/5.0 GHz bands) and standardized protocols for the modulation of the RF signals and the exchanging of information packets (for example, IEEE 802.11x). By extracting different types of information from the exchanged signals, and utilizing the layout of the network (i.e., the network geometry) the mobile device may determine position within a predefined reference coordinate system.

It should be appreciated that embodiments described herein may be implemented through the execution of instructions, for example as stored in the memory 605 or other element, by processor 601 of device and/or other circuitry of device and/or other devices. Particularly, circuitry of device, including but not limited to processor 601, may operate under the control of a program, routine, or the execution of instructions to execute methods or processes in accordance embodiments described herein. For example, such a program may be implemented in firmware or software (e.g. stored in memory 605 and/or other locations) and may be implemented by processors, such as processor 601, and/or other circuitry of device. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device 600 itself and/or some or all of the functions, engines or modules described herein may be performed by another system connected through I/O controller 625 or network interface 610 (wirelessly or wired) to device. Thus, some and/or all of the functions may be performed by another system and the results or intermediate calculations may be transferred back to device. In some embodiments, such other device may comprise a server configured to process information in real time or near real time. In some embodiments, the other device is configured to predetermine the results, for example based on a known configuration of the device. Further, one or more of the elements illustrated in FIG. 6 may be omitted from the device 600. For example, one or more of the sensors 631 may be omitted in some embodiments.

The teachings herein may be incorporated into (for example, implemented within or performed by) a variety of apparatuses (for example, devices). For example, one or more aspects taught herein may be incorporated into a phone (for example, a cellular phone), a personal data assistant, a tablet, a mobile computer, a laptop computer, a tablet, an entertainment device (for example, a music or video device), a headset (for example, headphones, an earpiece, etc.), a medical device (for example, a biometric sensor, a heart rate monitor, a pedometer, an electrocardiogram (EKG) device, etc.), a user I/O device, a computer, a server, a point-of-sale device, an entertainment device, a set-top box, or any other suitable device. These devices may have different power and data requirements and may result in different power profiles generated for each interest point or set of interest points.

In some aspects a wireless device may comprise an access device (for example, a Wi-Fi access point) for a communication system. Such an access device may provide, for example, connectivity to another network through transceiver 140 (for example, a wide area network such as the Internet or a cellular network) via a wired or wireless communication link. Accordingly, the access device may enable another device (for example, a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in random-access memory (RAM), flash memory, read-only memory (ROM), erasable programmable read-only memory (EPROM), electronically erasable programmable read-only memory (EEPROM), registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions or modules described may be implemented in hardware (for example, hardware 162), software (for example, software 165), firmware (for example, firmware 163), or any combination thereof. If implemented in software as a computer program product, the functions or modules may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for geofenced AP measurement data collection, the method comprising:
obtaining a geofence defining a geographically bounded area within an environment;
obtaining an AP measurement configuration associated with the geofence, wherein the AP measurement configuration includes one or more of: disabled, passive, or post-processed configurations;
determining a device is located within the geofence; and
collecting data according to the AP measurement configuration.

2. The method of claim 1, wherein the AP measurement configuration is a first AP measurement configuration associated with a first wireless technology.

3. The method of claim 2, wherein the method further comprising obtaining a second AP measurement configuration associated with the geofence and associated with a second wireless technology different from the first wireless technology, wherein the second AP measurement configuration includes one or more of: disabled, passive, or post-processed configurations.

4. The method of claim 1, wherein the collecting the data according to the post-processed configuration includes post-processing device position data calculated over a prior period of time at the end of a batch defined by an end-AP-data-collection trigger.

5. The method of claim 1, wherein the collecting the data according to the passive configuration includes sending measurements and positioning data to a server without post-processing of data prior to the sending.

6. The method of claim 1, wherein parameters of one or both of the AP measurement configuration or the geofence is determined by one or both of: the mobile device and a server.

7. The method of claim 1, wherein the collecting the data according to the AP measurement configuration includes the mobile device performing one or more of: radio frequency signal strength measurement, radio frequency based distance estimation to an AP, initializing one or more motion sensors at the mobile device, calculating GNSS based position, or any combination thereof.

8. The method of claim 1, wherein the AP measurement configuration is based on a quality or density of AP measurement coverage previously obtained within the geofence.

9. A mobile device to perform geofenced crowdsourcing comprising:
memory; and
a processor coupled to the memory, the processor and memory together configured to:
obtain a geofence defining a geographically bounded area within an environment;
obtain an AP measurement configuration associated with the geofence, wherein the AP measurement configuration includes one or more of: disabled, passive, or post-processed configurations;
determine a device is located within the geofence; and
collect data according to the AP measurement configuration.

10. The mobile device of claim 9, wherein the AP measurement configuration configures the mobile device for a first wireless technology.

11. The mobile device of claim 10, wherein the processor and memory are further configured to obtain a second AP measurement configuration associated with the geofence and associated with a second wireless technology different from the first wireless technology, wherein the second AP measurement configuration includes one or more of: disabled, passive, or post-processed configurations.

12. The mobile device of claim 9, wherein the processor configured to collect the data according to the post-processed configuration comprises post-processing device position data calculated over a prior period of time at the end of a batch defined by an end-AP-data-collection trigger.

13. The mobile device of claim 9, wherein the processor configured to collect the data according to the passive configuration comprises sending measurements and positioning data to a server without post-processing of data prior to the sending.

14. The mobile device of claim 9, wherein parameters of one or both of the AP measurement configuration or the geofence is determined by one or both of: the mobile device and a server.

15. The mobile device of claim 9, wherein the collection of the data according to the AP measurement configuration includes the mobile device performing one or more of: radio frequency signal strength measurement, radio frequency based distance estimation to an AP, initializing one or more motion sensors at the mobile device, calculating GNSS based position, or any combination thereof.

16. The mobile device of claim 9, wherein the AP measurement configuration is based on a quality or density of AP measurement coverage previously obtained within the geofence.

17. A machine readable non-transitory storage medium having stored therein program instructions that are executable by a processor to:
obtain a geofence defining a geographically bounded area within an environment;
obtain an AP measurement configuration associated with the geofence, wherein the AP measurement configuration includes one or more of: disabled, passive, or post-processed configurations;
determine a device is located within the geofence; and
collect data according to the AP measurement configuration.

18. The medium of claim 17, wherein the AP measurement configuration is a first AP measurement configuration associated with a first wireless technology.

19. The medium of claim 18, wherein the medium further comprising instructions to obtain a second AP measurement configuration associated with the geofence and associated with a second wireless technology different from the first wireless technology, wherein the second AP measurement configuration includes one or more of: disabled, passive, or post-processed configurations.

20. The medium of claim 17, wherein the processor-executable program instructions to collect the data according to the post-processed configuration includes instructions for post-processing device position data calculated over a prior period of time at the end of a batch defined by an end-AP-data-collection trigger.

21. The medium of claim 17, wherein the processor-executable program instructions to collect the data according to the passive configuration includes instructions for sending measurements and positioning data to a server without post-processing of data prior to the sending.

22. The medium of claim 17, wherein parameters of one or both of the AP measurement configuration or the geofence is determined by one or both of: the mobile device and a server.

23. The medium of claim 17, wherein the collection of the data according to the AP measurement configuration includes the mobile device performing one or more of: radio frequency signal strength measurement, radio frequency based distance estimation to an AP, initializing one or more motion sensors at the mobile device, calculating GNSS based position, or any combination thereof.

24. The medium of claim 17, wherein the AP measurement configuration is based on a quality or density of AP measurement coverage previously obtained within the geofence.

25. An apparatus for performing geofenced measurement collection, the apparatus comprising:
means for obtaining a geofence defining a geographically bounded area within an environment;
means for obtaining an AP measurement configuration associated with the geofence, wherein the AP measurement configuration includes one or more of: disabled, passive, or post-processed configurations;
means for determining a device is located within the geofence; and
means for collecting data according to the AP measurement configuration.

26. The apparatus of claim 25, wherein the AP measurement configuration is a first AP measurement configuration associated with a first wireless technology.

27. The apparatus of claim 26, further comprising means for obtaining a second AP measurement configuration associated with the geofence and associated with a second wireless technology different from the first wireless technology, wherein the second AP measurement configuration includes one or more of: disabled, passive, or post-processed configurations.

28. The apparatus of claim 25, wherein the means for collecting data according to the post-processed configuration includes post-processing device position data calculated over a prior period of time at the end of a batch defined by an end-AP-data-collection trigger.

29. The apparatus of claim 25, wherein the means for collecting data according to the passive configuration includes sending measurements and positioning data to a server without post-processing of data prior to the sending.

30. The apparatus of claim 25, wherein the means for collecting the data according to the AP measurement configuration includes means for the mobile device to perform one or more of: radio frequency signal strength measurement, radio frequency based distance estimation to an AP, initializing one or more motion sensors at the mobile device, calculating GNSS based position, or any combination thereof.
